(19) United States
(12) Patent Application Publication
(10) Pub. No.: US 2017/0051667 A1
(43) Pub. Date: Feb. 23, 2017

(54) HIGH EFFICIENCY SELF-CONTAINED MODULAR TURBINE ENGINE POWER GENERATOR

(71) Applicant: Godman Energy Group, Inc., Meriden, CT (US)

(72) Inventor: John Godman, Meriden, CT (US)

(73) Assignee: Godman Energy Group, Inc., Meriden, CT (US)

(21) Appl. No.: 15/238,804

(22) Filed: Aug. 17, 2016

Related U.S. Application Data
(60) Provisional application No. 62/207,175, filed on Aug. 19, 2015.

(51) Int. Cl. F02C 3/045; F02C 3/04; F02C 7/06; F01D 25/00; F04D 29/54; F04D 29/02; F01D 5/34; F01D 9/04; H02K 7/18; F04D 29/32

(52) U.S. Cl. CPC F02C 3/045; H02K 7/1823; F02C 3/04; F02C 7/06; F04D 29/324; F04D 29/542; F04D 29/023; F01D 5/34; F01D 9/041; F01D 25/005; F05D 2220/76; F05D 2240/91

(57) ABSTRACT

A high efficiency self-contained modular turbine engine unit for generating power includes a housing defining an air intake and an exhaust port. A turbine engine is positioned and operable within the housing. The turbine engine includes a drive shaft a compressor rotor assembly, a compressor vane assembly, a combustor and diffuser assembly, a turbine vane assembly and a turbine rotor assembly. The combustor and diffuser assembly is a one-piece unit defining a shroud extending forwardly therefrom and a plurality of combustion flow channels extending rearwardly and radially inwardly thereby forming a flowpath angle in the range from about 15° to about 35° with the drive shaft. An igniter is positioned in each flow channel to ignite a fuel/oxygen mixture introduced into the compressor rotor assembly. External components required for operation of turbine engine are mounted within the housing.

### CROSS REFERENCE

This application claims the benefit of U.S. Provisional Patent Application No. 62/207,175 filed on Aug. 19, 2015, the contents of which are incorporated herein by reference in their entirety.

### FIELD OF THE INVENTION

The present invention is directed to a high efficiency self-contained modular turbine engine unit for generating power. More particularly, the present invention is directed to a self-contained modular turbine engine power generator that is readily deliverable to, and operable in, remote areas, refugee camps and shelters, temporary emergency sites and hospitals, and the like, while exhibiting substantially improved operating thermal efficiency.

### DESCRIPTION OF THE RELATED ART

In general, a turbine is a spinning device that uses the action of a fluid to produce work. Gas turbine engines were initially designed to power aircraft. A typical gas turbine engine for providing thrust for an aircraft is shown in FIG. P1. The gas turbine includes a compressor to draw in and compress gas, typically air, a combustor wherein fuel is added to the compressed air and ignited to heat the compressed air, a turbine to extract power from the hot air flow, and a nozzle to extract thrust from the turbine exhaust. When a gas turbine engine is used to produce mechanical power, typically the nozzle is replaced by an energy extraction device such as another power turbine as shown in FIG. P2, to extract mechanical energy from the hot air exhaust of the first turbine. In such a configuration, a portion of the first turbine power is used to drive the compressor, and the remaining first turbine power is used to drive an output shaft that, in turn, turns the energy extraction device which may be an electrical generator or a propeller drive shaft.

Typical land-based gas turbine engines derived from the gas turbine engine for providing thrust for an aircraft are commonly referred to as aeroderivative gas turbine engines. Aeroderivative gas turbine engines are commonly used for peak load electrical power generation and to drive compressors for natural gas pipelines. Such aeroderivative gas turbine engines must be started by some external means such as an external motor, another gas turbine or an auxiliary power unit (“APU”). Typically, aeroderivative gas turbine engines are employed to produce electricity in the range of about 15 MW to about 65 MW depending upon the size of its parent aircraft engine thrust output rating.

The working fluid within a gas turbine engine represents a fixed amount of air passing through the components of the gas turbine and exhibits a volume-pressure relationship referred to as the Brayton cycle wherein pressure is inversely proportional to velocity. One significant disadvantage of the gas turbine engine is its inherent low efficiency. Current aeroderivative gas turbine engines exhibit a thermal efficiency of about 40%. In some configurations, a combined cycle is employed to increase efficiency. In a combined cycle gas turbine (“CCGT”) power plant, a gas turbine and a steam turbine are used in combination to achieve greater efficiency than would be possible independently. The gas turbine drives an electrical generator and the gas turbine exhaust is passed to a heat exchanger to thereby supply a steam turbine which may generate additional electricity. Such a configuration may exhibit a combined-cycle thermal efficiency of up to about 58%.

Typical gas turbine engines, including aeroderivative gas turbine engines, are designed to be encapsulated with in casing referred to a nacelle. The nacelle is configured to be as small as possible while providing space for all of the engine accessories and for necessary ventilation for accessory and engine cooling. Such accessory systems typically are mounted to the gas turbine engine and powered thereby as well. Such accessory systems typically include, for example, an electronic control system, fuel system and pumps, hydraulic system and pumps, an accessory drive or gearbox, an engine starter or APU, and numerous instrumentation devices and cabling systems. Typically, such accessory systems contribute to the low efficiency exhibited by aeroderivative gas turbines.

Typical gas turbine engines, including aeroderivative gas turbine engines, require a bleed air system whereby compressed air drawn out of the gas flowpath upstream of the fuel-burning stage or combustor. Such bleed air is used for internal cooling of the engine, cross-starting another engine, engine and airframe anti-icing, cabin pressurization, pneumatic actuators, air-driven motors, and for pressurizing the hydraulic reservoir, waste and water storage tanks. Typically, such bleed air systems contribute to the low efficiency exhibited by aeroderivative gas turbines.

Substantially uninterruptable power is needed in remote areas, refugee camps and shelters, temporary emergency sites and hospitals, and the like. While aeroderivative gas turbine engines may be used to provide power at such remote areas or emergency sites, constructing a facility and erecting a gas turbine power plant within the facility may take weeks or longer and require construction and assembly skills that may not be available at a remote area or emergency site. In addition, many gas turbine power plants require a significant amount of area or footprint in which the power plant may operate.

What is needed is a high efficiency, compact, self-contained power plant that is readily transportable and deployable to remote areas and emergency sites.

### SUMMARY OF THE INVENTION

In one aspect, the present invention is directed to a high efficiency self-contained modular turbine engine unit for generating power. The modular turbine engine unit includes a housing having a housing frame, a top panel, a bottom panel, a first side panel, a second side panel, a third side panel and a fourth side panel, each of the panels being removeably secured to the housing frame. The housing defines an air intake and an exhaust port. A turbine engine is positioned and operable within the housing. The turbine engine includes a drive shaft defining a drive shaft centerline, at least one compressor rotor assembly mounted on the drive shaft, and at least one compressor vane assembly mounted on the drive shaft proximate to and downstream from the at least one compressor rotor assembly. A combustor and diffuser assembly is mounted on the drive shaft proximate to and downstream from the at least one compressor vane assembly. The combustor and diffuser assembly is a one-piece unit defining a shroud extending forwardly therefrom to define a flowpath for compressed air exiting the at least one compressor vane assembly. The combustor and diffuser assembly includes a plurality of combustion flow channels extending rearwardly and radially inwardly thereby forming a flowpath angle in the range from about 15° to about 35° with the drive shaft centerline. An igniter is positioned on a forward end of each flow channel configured to ignite a fuel/oxygen mixture introduced into the at least one compressor rotor assembly. At least one turbine vane assembly is mounted on the drive shaft proximate to and downstream from the combustor and diffuser assembly. At least one turbine rotor assembly is mounted on a drive shaft proximate to and downstream from the at least one turbine vane assembly. A forward engine mount and a rear engine mount are configured for positioning and securing the turbine engine within the housing. The external components required for operation of the turbine engine are mounted within the housing on at least one of the top panel, first side panel, second side panel, third side panel and fourth side panel.

### BRIEF DESCRIPTION OF THE DRAWINGS

FIG. P1 is a block diagram of a typical prior art gas turbine engine configuration.

FIG. P2 is a block diagram of another typical prior art gas turbine engine configuration.

FIG. P3 is a cross-sectional view of a typical prior art aeroderivative gas turbine engine.

FIG. 1A is an elevation view of a front side of one embodiment of a self-contained modular turbine engine unit in accordance with the present invention.

FIG. 1B is a top view of the self-contained modular turbine engine unit of FIG. 1A.

FIG. 1C is a bottom view of the self-contained modular turbine engine unit of FIG. 1A.

FIG. 1D is an elevation view of one side of the self-contained modular turbine engine unit of FIG. 1A.

FIG. 1E is an elevation view of a back side of the self-contained modular turbine engine unit of FIG. 1A.

FIG. 1F is an elevation view of another side of the self-contained modular turbine engine unit of FIG. 1A.

FIG. 2A is an isometric view of the self-contained modular turbine engine unit of FIG. 1A with some panels of the housing removed.

FIG. 2B is a side elevation view of the self-contained modular turbine engine unit of FIG. 2A.

FIG. 2C is a top view of the self-contained modular turbine engine unit of FIG. 2A.

FIG. 2D is a sectional view of the self-contained modular turbine engine unit of FIG. 2A taken along line D-D of FIG. 2B.

FIG. 3 is a schematic representation of one embodiment of an air intake for a turbine engine of the self-contained modular turbine engine unit of FIG. 2A.

FIG. 4A is an isometric view of the self-contained modular turbine engine unit of FIG. 1A wherein the housing includes alternate panels.

FIG. 4B is a side elevation view of the self-contained modular turbine engine unit of FIG. 4A.

FIG. 4C is a front elevation view of the self-contained modular turbine engine unit of FIG. 4A.

FIG. 4D is a sectional view of the self-contained modular turbine engine unit of FIG. 4A taken along line C-C of FIG. 4B.

FIG. 4E is another side elevation view of the self-contained modular turbine engine unit of FIG. 4A.

FIG. 5A is an isometric view of two of the self-contained modular turbine engine units of FIG. 1A shown in a stacked configuration.

FIG. 5B is a side elevation view of the self-contained modular turbine engine units of FIG. 4A.

FIG. 5C is a sectional view of the self-contained modular turbine engine units of FIG. 5A taken along line C-C of FIG. 5B.

FIG. 6 is an isometric view of the housing frame of the self-contained modular turbine engine unit of FIG. 1A.

FIG. 7A is another isometric view of the housing frame of FIG. 6.

FIG. 7B is another isometric view of the housing frame of FIG. 6.

FIG. 8A is a side elevation view of one embodiment of the gas turbine engine of the self-contained modular turbine engine unit of FIG. 1A.

FIG. 8B is an elevation view looking into the rearward end of the gas turbine engine of FIG. 8A.

FIG. 8C is a sectional view of the gas turbine engine of FIG. 8A taken along line C-C of FIG. 8B.

FIG. 8D is an elevation view looking into the forward end of the gas turbine engine of FIG. 8A.

FIG. 9A is an isometric view of the core and mechanical output assembly of the gas turbine engine of FIG. 8A.

FIG. 9B is an elevation view looking into the rearward end of core and mechanical output assembly of FIG. 9A.

FIG. 9C is a sectional view of the core and mechanical output assembly of FIG. 9A taken along line C-C of FIG. 9B.

FIG. 10A is an isometric view of another embodiment of the core of the gas turbine engine of FIG. 8A.

FIG. 10B is an elevation view looking into the rearward end of core and mechanical output assembly of FIG. 10A.

FIG. 10C is a sectional view of the core and mechanical output assembly of FIG. 10A taken along line C-C of FIG. 10B.

FIG. 11A is front elevation view of the self-contained modular turbine engine unit of FIG. 1A wherein additional components are included therewith.

FIG. 11B is a side elevation view of the self-contained modular turbine engine unit of FIG. 4A.

FIG. 11C is a sectional view of the self-contained modular turbine engine unit of FIG. 11A taken along line C-C of FIG. 11B.

FIG. 12 is a listing of the mechanical properties of certain refractory ceramics.

FIG. 13 is a sectional view of another embodiment of a self-contained modular turbine engine of the present invention.

FIG. 14A is an isometric view of a combustor and diffuser assembly of the turbine engine of FIG. 13.

FIG. 14B is a front view (looking aft) of the combustor and diffuser assembly of FIG. 14A.

FIG. 14C is a rear view (looking forward) of the combustor and diffuser assembly of FIG. 14A.

FIG. 14D is a cross-sectional view of the combustor and diffuser assembly of FIG. 14A taken along line A-A of FIG. 14C.

FIG. 14E is a detail perspective view of the combustor and diffuser assembly of FIG. 14A taken from line C-C of FIG. 14D.

### DETAILED DESCRIPTION OF THE INVENTION

The present invention provides a high efficiency self-contained modular turbine engine power generator that is readily deliverable to, and operable in, remote areas, refugee camps and shelters, temporary emergency sites and hospitals, and the like. The high efficiency self-contained modular turbine engine power generator of the present invention is easily transportable and deployable, and provides reliable high efficiency power in a compact space. The design and configuration of the high efficiency self-contained modular turbine engine power generator eliminates the need for an accessory gearbox. All external components required for operation of the modular turbine engine are mounted on the internal walls or panels of the high efficiency self-contained unit eliminating the complexity of mounting such hardware to the turbine engine itself thereby substantially reducing the maintenance and wear issues encountered with the high temperature and harmonics associated with the operation of the turbine engine. Moreover, all external components required for operation of the modular turbine engine can be powered with twelve or twenty-four voltage power supplied by an accessory electric motor or one or more batteries or solar power.

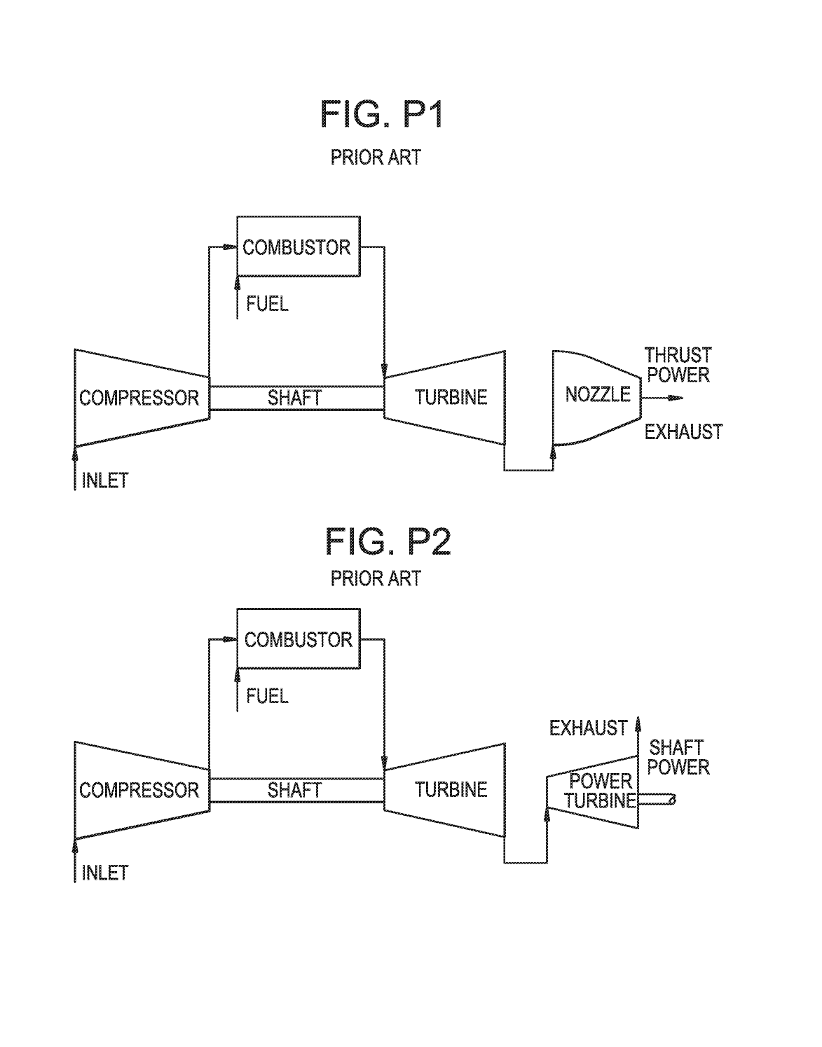

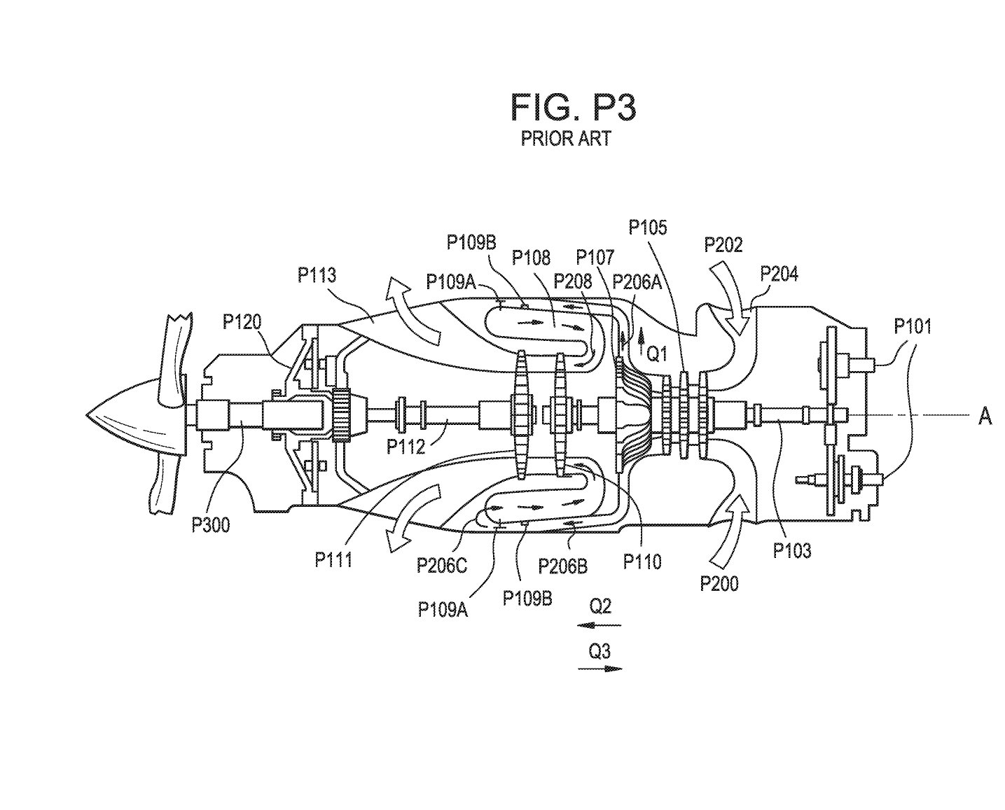

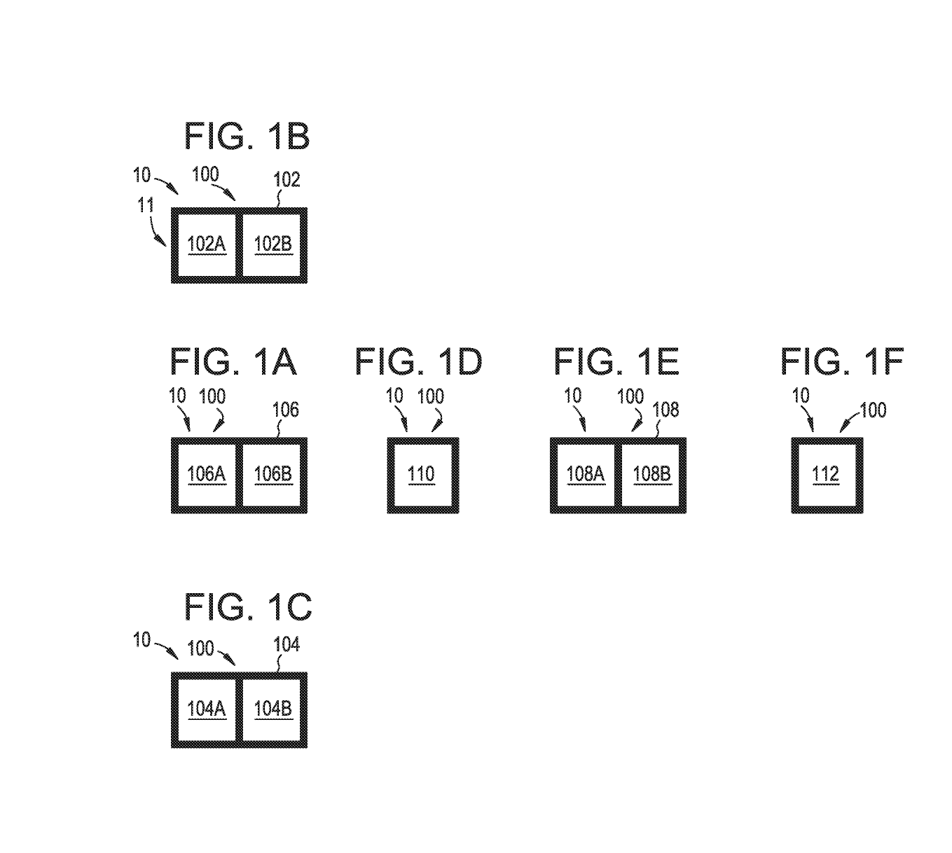

One embodiment of a self-contained modular turbine engine unit for generating power in accordance with the present invention is shown in FIGS. 1A, 1B, 1C, 1D, 1E and 1F designated generally by the reference number 10 and is hereinafter referred to “modular unit 10”. The modular unit 10 includes a containment vessel or modular unit housing 100 that defines an exoskeleton 11 in which the module unit 10 be mounted in a cantilevered configuration wherein a front and/or rear portion of the module unit 10 extends beyond a support or support fulcrum. The housing 10 has a first side or housing cover or housing top 102, a second side or housing base or housing bottom 104, a third side or housing front 106, a fourth side or housing back 108, a fifth side or housing side 110, and a sixth side or housing side 112. In one embodiment, housing top 102 defines housing top portions or panels 102A and 102B. In one embodiment, housing bottom 104 defines housing bottom portions or panels 104A and 104B. In one embodiment, housing front 106 defines housing front portions or panels 106A and 106B. In one embodiment, housing back 108 defines housing back portions or panels 108A and 108B.

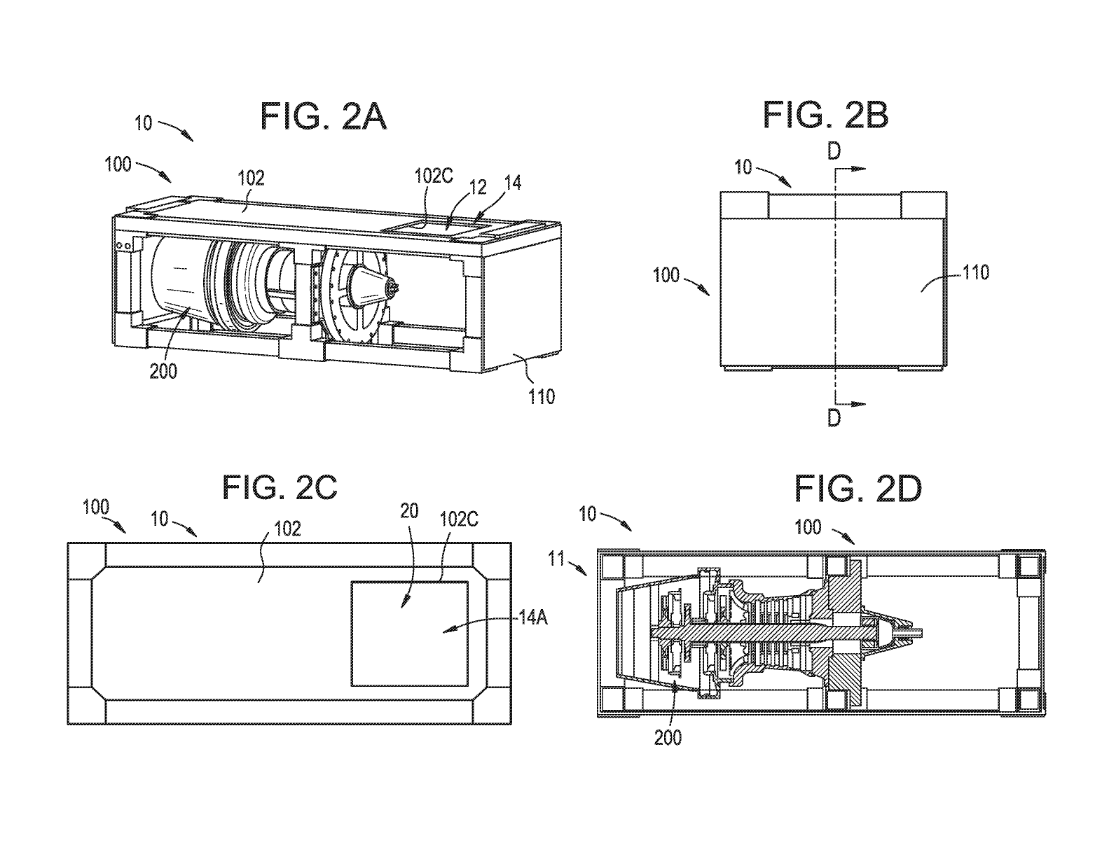

A self-contained modular turbine engine unit, modular unit 10, is shown in FIG. 2A housed within the housing 100 with the housing front panels 106 A and 106B removed therefrom. The modular unit 10 includes a turbine engine 200 positioned and operable within the housing 100. In one embodiment of the housing 100, the housing top 102 defines an opening 102C that provides for an airflow or air intake 20 for providing air to the turbine engine 200 positioned therein. In one embodiment, a fuel 14 is introduced with the air 12. In one embodiment, air 12 and fuel 14 comprise a fuel/air or fuel/oxygen mixture 14A. The fuel may be any hydrogen-based gaseous fuel such as for example natural gas, synthetic natural gas (SNG or syngas), propane and the like; liquid fuel such as jet fuel, diesel fuel, distillate and oil, or any refined petroleum product and the like; certain waste gases and biofuel; and other synthetic fuels. Thus, the present invention provides for the introduction of the fuel 14 together with the air 12 via the air intake 20 prior to compressing the fuel/air or fuel/oxygen mixture.

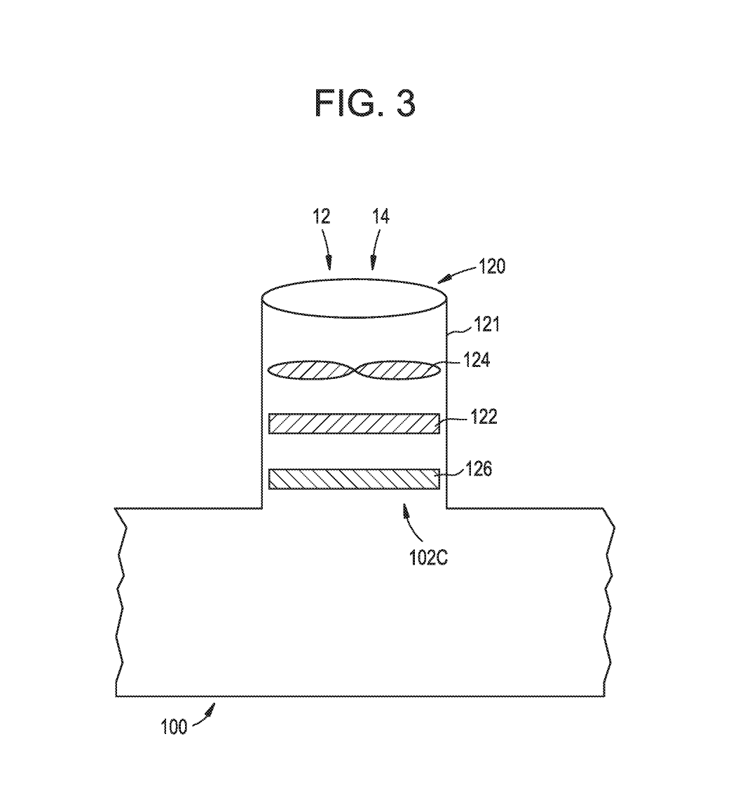

In one embodiment and as shown in FIG. 3, the housing 100 includes an air intake assembly 120 having an air intake housing 121. In embodiment, the air intake housing 121 defines a cylindrical configuration and the air intake opening 102C defines a corresponding circular configuration. In one embodiment, the air intake assembly 120 includes an air filtration system 122 positioned therein. In one embodiment, the air intake assembly 120 includes a rotor 124 positioned therein and configured for generating power such as, for example, a windmill assembly. In one embodiment, the rotor 124 provides power for recharging a battery or battery pack contained within the modular unit 10. In one embodiment, the air intake assembly 120 includes a mixer 126 positioned therein and configured for mixing air or oxygen with fuel to provide a fuel/air admixture 128 to the turbine engine 200.

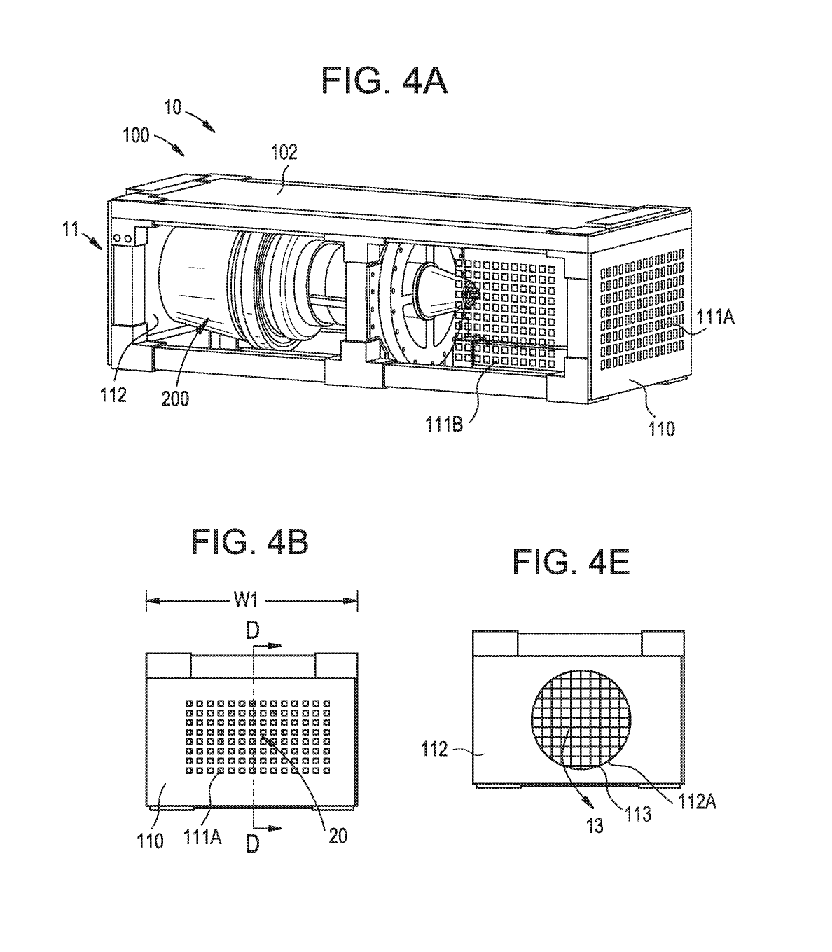

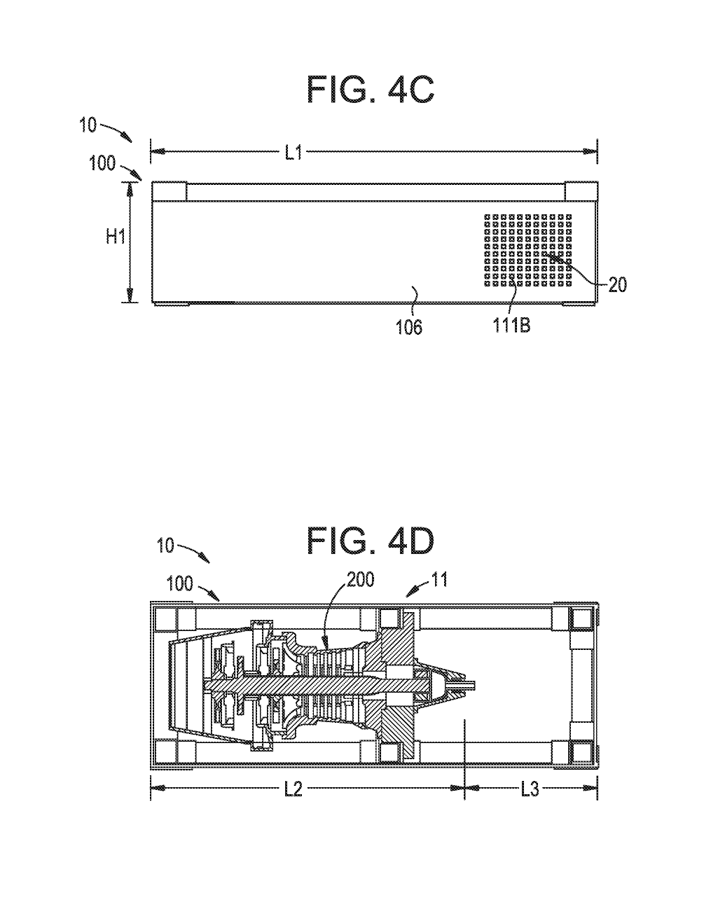

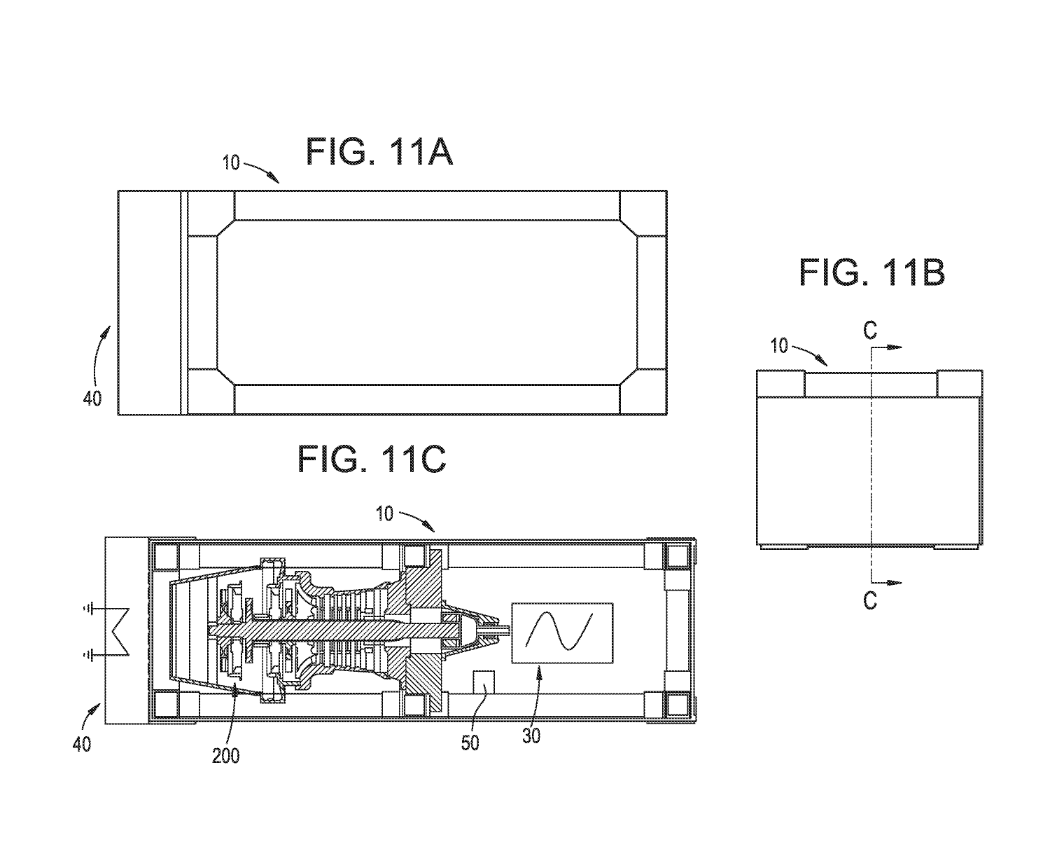

A self-contained modular turbine engine unit, modular unit 10, is shown in FIG. 4A housed within the housing 100 with the housing front panels 106A and 106B removed therefrom. The modular unit 10 includes the turbine engine 200 positioned and operable within the housing 100. In one embodiment of the housing 100, the housing side 110 defines an opening grid 111A. As shown in FIG. 4C and in phantom in FIG. 4A, the air intake assembly 120 may include, as an alternative to opening grid 111A or in addition to opening grid 111A, an opening grid 111B. The housing 110 further defines an opening or exhaust port 113 that provides for an exhaust flow 13 of the turbine engine 200 positioned therein. In one embodiment of the housing 100, the housing side 112, positioned at the rearward end of the turbine engine 200, defines an opening grid 112A that provides for the exhaust flow 13. In one embodiment and as shown in FIGS. 11A and 11C, the modular unit 10 includes a heat reclamation unit 40 positioned to receive the exhaust flow 13 of the turbine engine 200 positioned therein. The heat reclamation unit 40 is available for generating steam or providing heat for other applications as required at each particular location at which the modular unit 10 is deployed.

The housing 110 defines a length L1. In one embodiment, L1 is in the range of up to about 120 inches. In one embodiment, L1 is in the range of up to about 96 inches. In one embodiment, L1 is in the range of about 84 inches to about 108 inches. In one embodiment, L1 is in the range of about 90 inches to about 96 inches.

The housing 110 defines a height H1. In one embodiment, H1 is in the range of up to about 48 inches. In one embodiment, H1 is in the range of up to about 36 inches. In one embodiment, H1 is in the range of about 24 inches to about 36 inches. In one embodiment, H1 is in the range of about 28 inches to about 32 inches.

The housing 110 defines a width W1. In one embodiment, W1 is in the range of up to about 48 inches. In one embodiment, W1 is in the range of up to about 42 inches. In one embodiment, W1 is in the range of about 34 inches to about 42 inches. In one embodiment, W1 is in the range of about 36 inches to about 40 inches.

In one embodiment, the housing length L1 includes a length L2 of turbine engine 200 and a remaining length L3. In one embodiment, the turbine engine length L2 is in the range of up to about 72 inches. In one embodiment, L2 is in the range of up to about 66 inches. In one embodiment, L2 is in the range of about 54 inches to about 66 inches. In one embodiment, L2 is in the range of about 58 inches to about 62 inches.

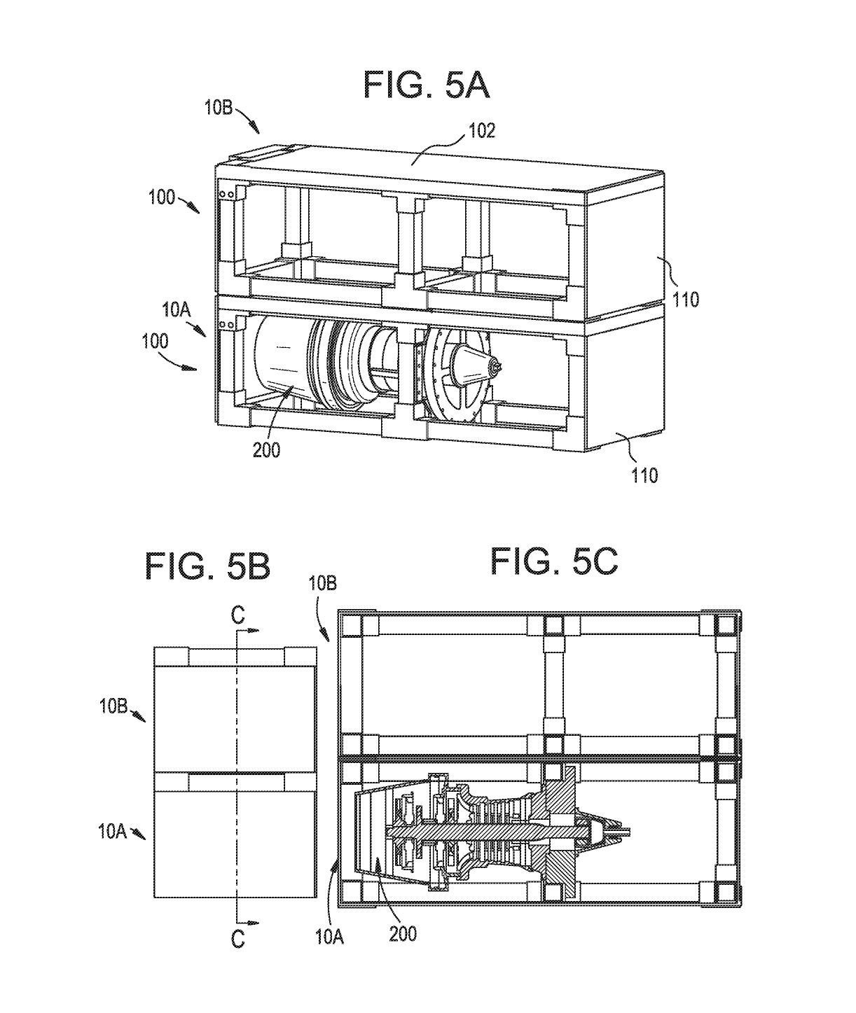

Two or more of the self-contained modular turbine engine units 10 can be configured together to produce a desired power output. A stacked configuration 20 of two of the self-contained modular turbine engine units 10A and 10B is shown in FIG. 5A. The turbine engine 200 is only shown with reference to module unit 10A. Each housing 100 is shown without front panels 106A and 106B. One embodiment of the housing 100 for each of the module units 10A and 10B includes at least one of the opening grid 111A and the opening grid 111B as shown in FIG. 4C and in phantom in FIGS. 4A to provide the air 12. While two of the self-contained modular turbine engine units 10 have been shown and described as configured together, the present invention is not limited in this regard as more than two of the self-contained modular turbine engine units 10 can be configured together without departing from the broader aspects of the present invention. While two of the self-contained modular turbine engine units 10 have been shown and described as stacked, the present invention is not limited in this regard as two or more of the self-contained modular turbine engine units 10 can be configured together in a side-by-side configuration or any other grid-like configuration without departing from the broader aspects of the present invention.

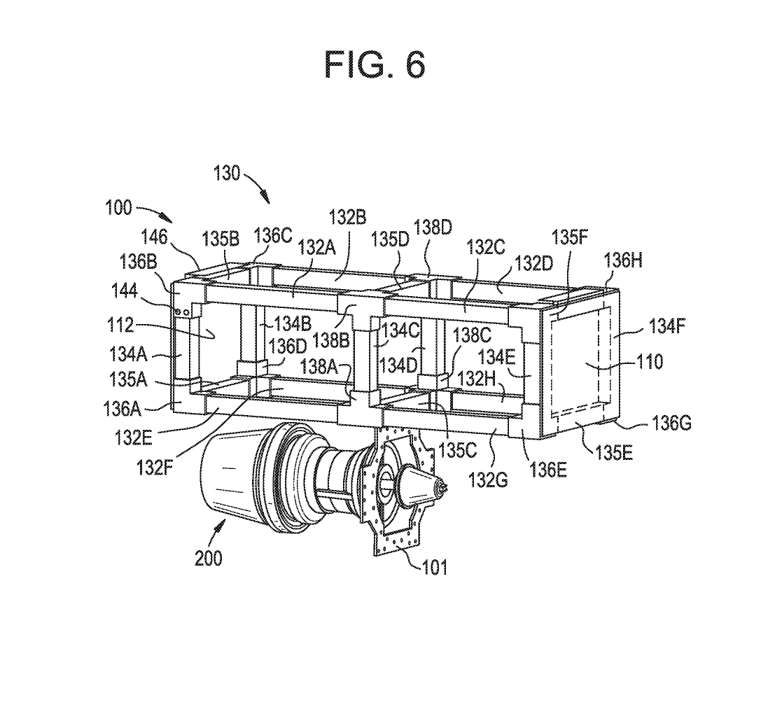

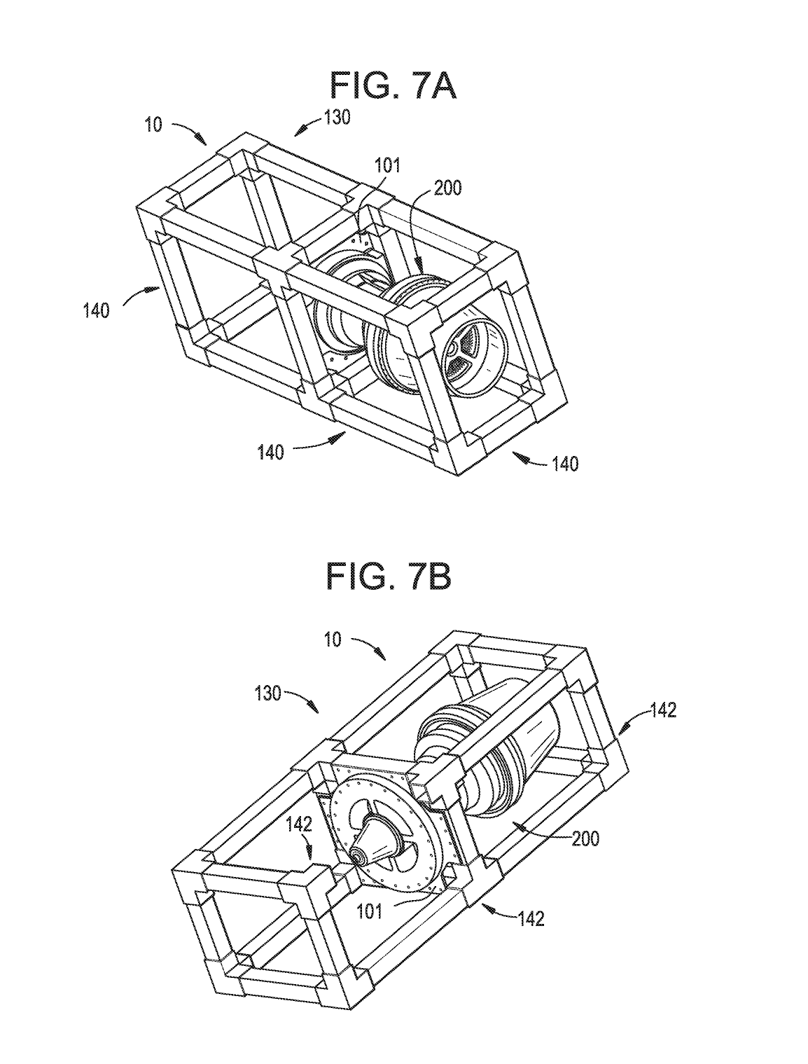

As further shown in FIGS. 6, 7A and 7B, the housing 100 of the modular unit 10 is designed to accept and enclose the turbine engine 200 therein. The housing 100 includes a structural assembly or frame assembly 130 to engage, receive and support the housing top 102, housing bottom 104, housing front 106, housing back 108, housing side 110 and housing side 112. In one embodiment, the housing 100 includes a housing center mount 101. In one embodiment, the frame assembly 130 includes: (i) periphery length members 132A, 132B, 132C, 132D, 132E, 132F, 132G and 132H; (ii) periphery elevation members 134A, 134B, 134C, 134D, 134E, and 134F (not shown); (iii) periphery width members 135A, 135B, 135C, 135D, and 135E and 135F (not shown); (iv) 3-member junctions 136A, 136B, 136C, 136D, 136E, 136F, 136G and 136H; and (v) 4-member junctions 138A, 138B, 138C and 138D.

The 3-member junction 136A engages and retains therein periphery length member 132E, periphery width member 135A and periphery elevation member 134A. The 3-member junction 136B engages and retains therein periphery length member 132A, periphery width member 135B and periphery elevation member 134A. The 3-member junction 136C engages and retains therein periphery length member 132B, periphery width member 135B and periphery elevation member 134B. The 3-member junction 136D engages and retains therein periphery length member 132F, periphery width member 135A and periphery elevation member 134B. The 3-member junction 136E engages and retains therein periphery length member 132G, periphery width member 135E and periphery elevation member 134E. The 3-member junction 136F engages and retains therein periphery length member 132D, periphery width member 135F and periphery elevation member 134E. The 3-member junction 136G engages and retains therein periphery length member 132H, periphery width member 135E and periphery elevation member 134F.

The 4-member junction 138A engages and retains therein periphery length members 132E and 132G, periphery width member 135C and periphery elevation member 134C. The 4-member junction 138B engages and retains therein periphery length members 132A and 132C, periphery width member 135D and periphery elevation member 134C. The 4-member junction 138C engages and retains therein periphery length members 132F and 132H, periphery width member 135C and periphery elevation member 134D. The 4-member junction 138D engages and retains therein periphery length members 132B and 132D, periphery width member 135D and periphery elevation member 134D.

The periphery length members 132A-132H, periphery elevation members 134A-134F and periphery width members 135A-135F are referred to herein collectively as frame members 140. The 3-member junctions 136A-136H and the 4-member junctions 138A-138D are referred to collectively herein as frame junctions 142. The frame members 140 and the frame junctions 142 are fabricated from suitable robust material capable of withstanding elevated temperatures such as for example metal and high-temperature plastic. Engagement and retention of the frame members 140 within the frame junctions 142 may be accommodated by press-fit, fasteners 144 such as for examples rivets or bolts and nuts, brackets 146, metal joining such as for example brazing or welding, plastic welding, use of adhesives, and the like.

While the frame assembly 130 has been shown and described as including the frame members 140 and the frame junctions 142, the present invention is not limited in this regard as the frame assembly 130 may be undivided or divided into additional sections than the frame members 140 and the frame junctions 142 without departing from the broader aspects of the present invention.

The housing 100 of the module unit 10 is adaptable to enclose and house a variety of known turbine engines as well as an improved turbine engine as described herein below. For example, the turbine engine 200 can be a turbofan engine, a free turbine series gas turbine engine (a “turboshaft engine”) or a geared turbofan engine. One example of a turbine engine 200 for use in the module unit 10 of the present invention is one of the T55 family of turboshaft engines available from Honeywell International Inc. (“Honeywell”). Another example of a turbine engine 200 for use in the module unit 10 of the present invention is a Honeywell ALF 502 turbofan engine or a Honeywell LF 507 geared turbofan engine.

One embodiment of a prior art aeroderivative gas turbine engine is shown in FIG. P3 and is referred to herein as “turbine engine P100.” Turbine engine P100 includes a drive shaft P103 having a centerline A, a three-stage axial flow compressor P105, a centrifugal compressor P107, a combustor P108 having a fuel nozzle 109A and an ignitor 109B therein, a compressor turbine P110 or gas producer, and an exhaust outlet P113. A free turbine or power turbine P111 is mounted to a turbine shaft 112 which in turn drives a reduction gearbox P120, which in turn drives a propeller drive shaft P300. An accessory gearbox P101 is mounted at a forward end of the drive shaft P103.

In operation, an airflow P200 is driven through the turbine engine P100. A first airflow P202 is introduced or drawn into an air inlet P204. The first airflow P202 is compressed via the axial flow compressor P105 and the centrifugal compressor P107. A second airflow P206A, or compressed air, exits the centrifugal compressor P107 in a direction indicated by the arrow Q1 which is generally orthogonal to the centerline A of the drive shaft P103. The second airflow P206A is first redirected approximately 90° in a direction indicated by the arrow Q2 which is generally aft. A third airflow P206C is redirected a second time approximately 180° in a direction indicated by the arrow Q3 which is generally forward, and introduced into the combustor P108. Heat is added to the third airflow P206C by injecting fuel into the combustor P108 via the fuel nozzle 109A and igniting it via the ignitor 109B on a continuous basis. The hot combustion exhaust or fourth airflow P208 is redirected a third time approximately 180° in the direction indicated by the arrow Q2 which is generally aft and passes through the compressor turbine P110 and the exhaust outlet P113.

While gas paths of certain particular turbine engines configured for aircraft flight are not substantially redirected, such a configuration in land-based aeroderivative gas turbine engines is known to require a substantially greater footprint at greater substantially increased cost to fabricate, assemble and operate than the configuration of the turbine engine P100 shown in FIG. P3. In contrast to the configuration of the turbine engine P100 shown in FIG. P3, the present invention provides a substantially more direct gas path from the compressor to the exhaust thereby substantially increasing the efficiency of an improved gas turbine engine as further described herein below.

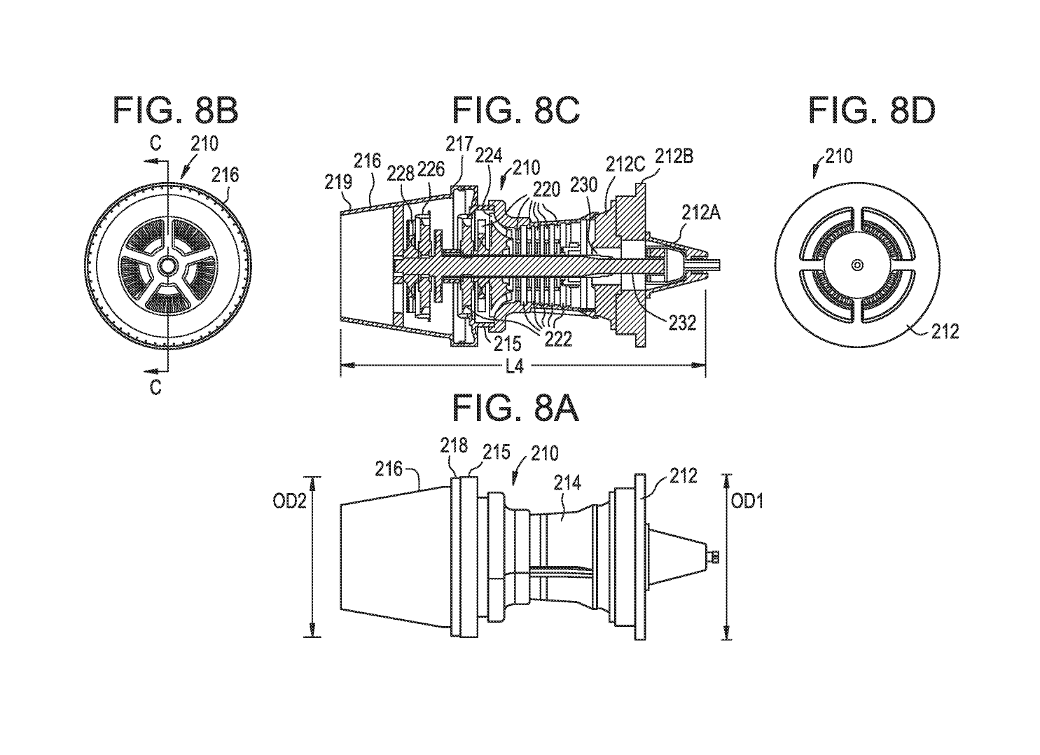

One embodiment of an improved gas turbine engine is shown in FIGS. 8A, 8B, 8C and 8D, and is referred to herein as “turbine engine 210.” The turbine engine 210 includes a forward engine mount 212 for positioning and securing the turbine engine 210 within the housing 100, for example by removeably and securing the forward engine mount 212 to the housing center mount 101 of the housing 100. The turbine engine 210 includes a compressor section containment case 214, a combustion section containment case 215, and a turbine section containment case 216. A front portion 217 of the turbine section containment case 216 provides for rearward mounting of the turbine engine 210 in the housing 100 and is referred to herein as rear engine mount 218. A rear portion 210 of the turbine section containment case 216 provides for turbine exhaust ducting providing a flowpath for the turbine exhaust 13 toward a selected panel of the housing 100, for example side 112 which includes the opening grid 112A (FIG. 4E).

The housing 100, particularly the frame members 140, are selectively fabricated to accommodate an overall length L4 of the turbine engine 210 and an outer diameter OD1 of the forward engine mount 212 and an outer diameter OD2 of the rear engine mount 218. Accordingly, H1 and W1 are greater than the larger of OD1 and OD2, and L1 is greater than L4. The size of the turbine engine 200, 210 can be selectively configured to produce a desired wattage output. In one embodiment, the turbine engine 200, 210 is selectively configured to produce about 3 MW to about 10 MW. Thus, the turbine engine 200, 210 does not provide a “one-size-fits-all” solution for producing a desired wattage output. Instead, the turbine engine 210 provides a one-design-makes-all™ solution for producing a desired wattage output.

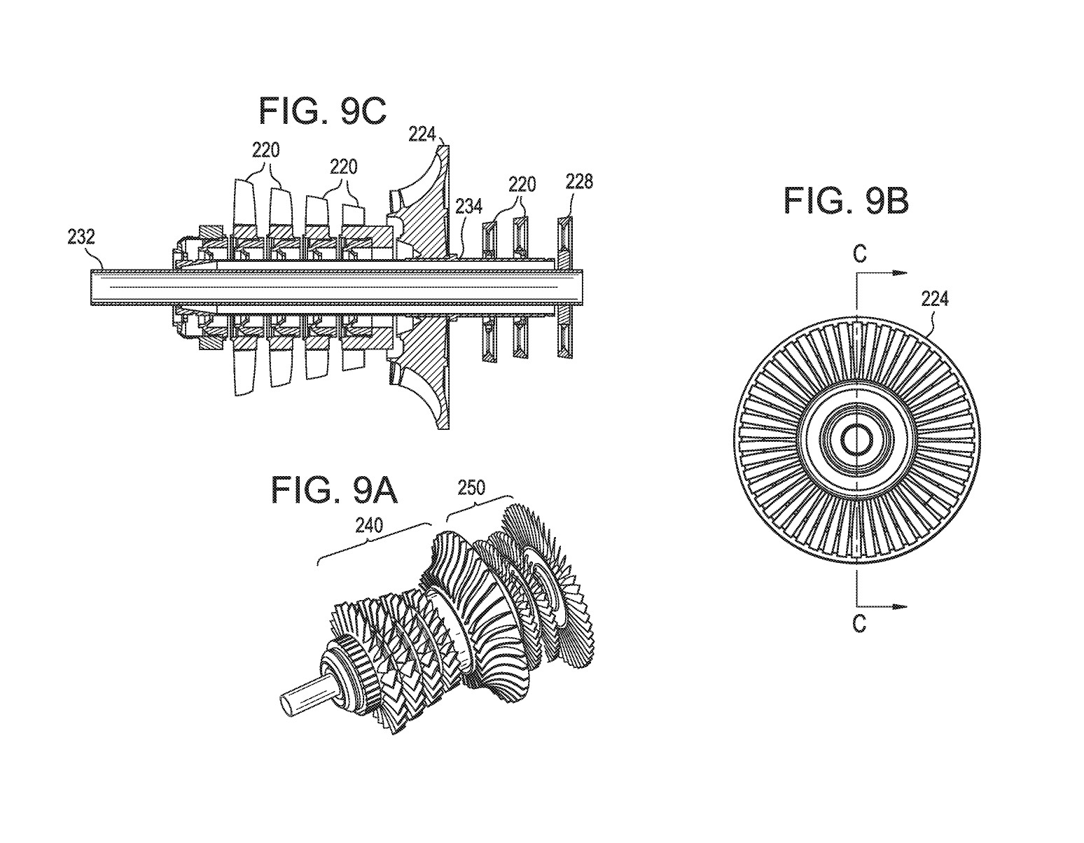

The turbine engine 210 includes at least one compressor rotor assembly 220 (four stages shown) and corresponding at least one compressor nozzle or vane assembly 222 (four stages shown) mounted on a drive shaft 230; and at least one turbine nozzle or vane assembly 226 and a corresponding at least one turbine rotor assembly 228 mounted on a drive shaft 230. The turbine engine 210 further includes a combustor and diffuser assembly 224. In one embodiment, the combustor includes one or more dual fuel nozzles or injectors (i.e., gaseous and liquid fuel). A compressor section or core 240 and a turbine section or mechanical output assembly 250 of the gas turbine engine 210 are further shown in FIGS. 9A, 9B and 9C. As shown in FIG. 11C, a generator 30 or other mechanical-to-electrical power conversion device is configured to receive and convert the mechanical power generated by the turbine engine 210 and more particularly the mechanical output assembly 250.

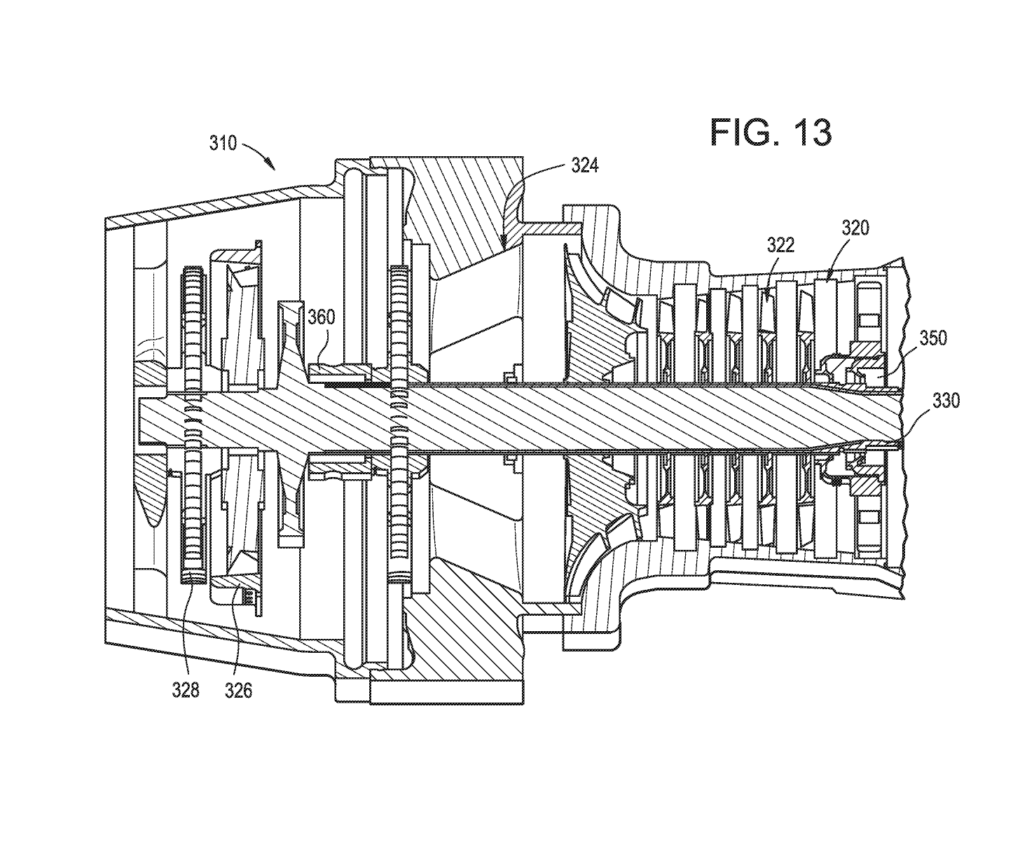

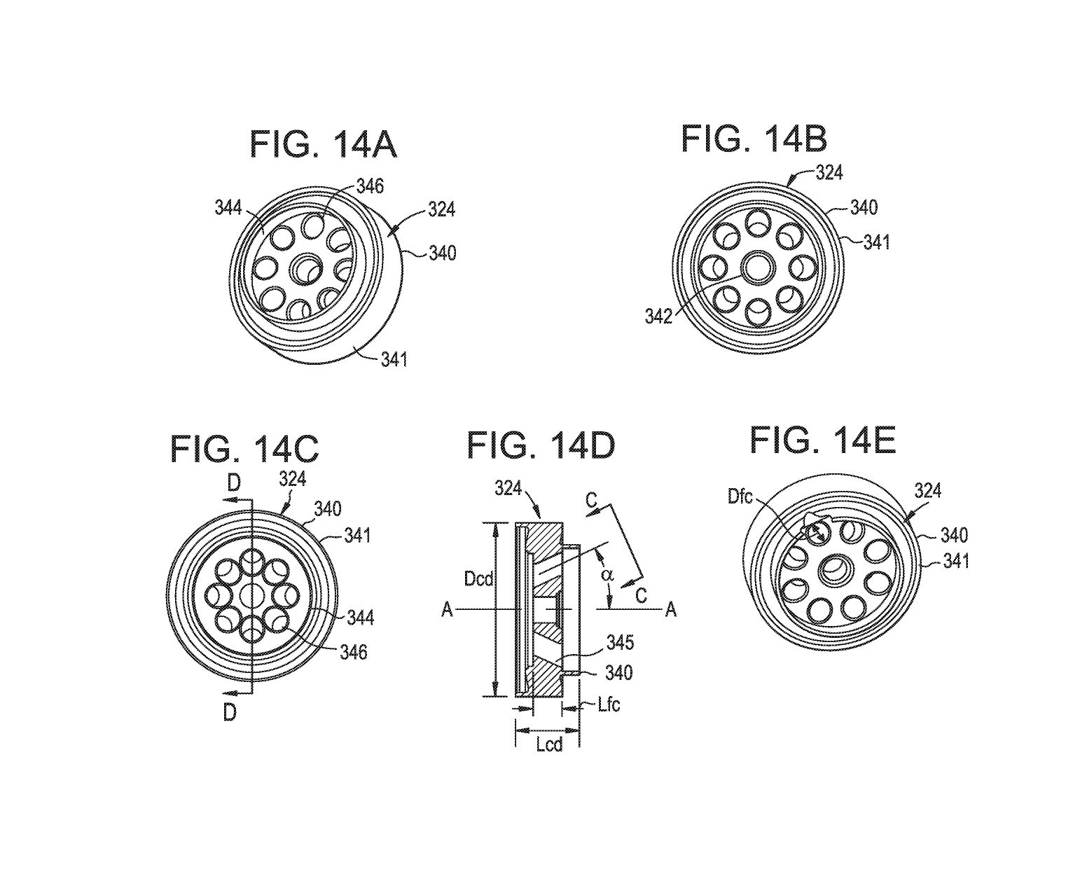

Another embodiment of the combustor and diffuser assembly 324 is shown in FIG. 13 and detail FIGS. 14A to 14E. The turbine engine 310 includes at least one compressor rotor assembly 320 (five stages shown) and a corresponding at least one compressor nozzle or vane assembly 322 (five stages shown) mounted on a drive shaft 330; and at least one turbine nozzle or vane assembly 326 and a corresponding at least one turbine rotor assembly 328 mounted on the drive shaft 230. The turbine engine 310 further includes a combustor and diffuser assembly 324. As shown in detail in FIGS. 14A to 14E, the combustor and diffuser assembly 324 is a one-piece unit 340 having an outer casing 341 and a center bore 342 therethrough for mounting the combustor and diffuser assembly 324 on to the shaft 330. In one embodiment, the combustor and diffuser assembly 324 defines a shroud 344 extending forwardly therefrom to define a flowpath for the compressed air exiting the last one of the compressor vane assemblies 322. The combustor and diffuser assembly 324 further defines a length Lcd and a diameter Dcd. In one embodiment, the diameter Dcd is from about 12 inches to about 36 inches. In one embodiment, the diameter Dcd is about 24 inches. In one embodiment, the length Lcd is between about 6 inches to about 12 inches. In one embodiment, the length Lcd is about 9 inches.

The compressed air is directed into one of a plurality of combustion flow channels 346 extending rearwardly and radially inwardly thereby forming a flowpath angle α with the centerline A of the drive shaft 330. In one embodiment, eight combustion flow channels 346 are defined in the combustor and diffuser assembly 324. An igniter 345 is positioned on a forward end of each flow channel 346 thereby igniting the fuel/oxygen mixture 14A (FIG. 2C) and combusting the compressed air. In one embodiment, the flowpath angle α is in the range from about 15° to about 35°. In one embodiment, the flowpath angle α is in the range from about 20° to about 30°. In one embodiment, the flowpath angle α is about 25°. Each of the flow channels 346 define a flow channel diameter Dfc and a flow channel length Lfc. In one embodiment, the diameter Dfc is from about 2 inches to about 6 inches. In one embodiment, the diameter Dfc is about 3 inches. In one embodiment, the length Lfc is between about 2 inches to about 6 inches. In one embodiment, the length Lfc is about 4 inches.

In contrast to the prior art configuration of the turbine engine P100 shown in FIG. P3, particularly the combustor P108 thereof, the combustor and diffuser assembly 324 does not include a fuel nozzle because the fuel 14 or fuel/air mixture 14A is introduced at the air inlet or forward end of the turbine engine 200, 210 of the present invention. Moreover, the flow channels 346 do not require the redirecting of the airflow passing therethrough in contrast to the redirecting of the air flow three times in the prior art configuration. In contrast to the prior art. The present invention provides a substantially more direct gas path from the compressor to the exhaust thereby substantially increasing the efficiency of an improved gas turbine engine as further described herein below.

In one embodiment of the turbine engine 310, the drive shaft 330 is supported by a forward magnetic bearing 350 and a rearward magnetic bearing 360. Bearing 350 and 360 are non-contact magnetic bearings which support the turbine engine 310 and further reduce the parasitic drag of the turbine engine 310 thereby further increasing the thermal efficiency of the turbine engine 310.

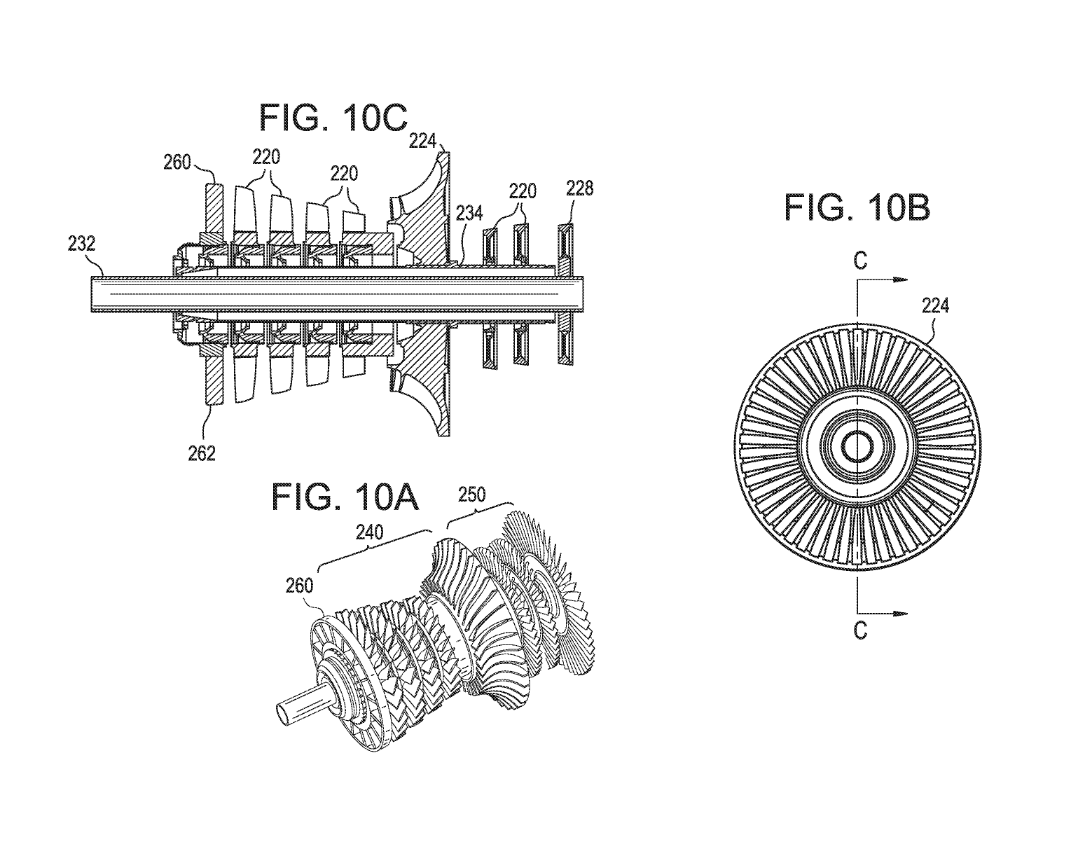

Another embodiment of the core 240 and the mechanical output assembly 250 of the gas turbine engine 210 are shown in FIGS. 10A, 10B and 10C. An electromagnetic starter assembly 260 is mounted on the drive shaft 230. The starter assembly 260 is described in U.S. Provisional Patent Application Ser. No. 62/142,194 filed on Apr. 2, 2015, which application is owned by the Applicant of the instant application, and which application is incorporated herein in its entirety. In the embodiment shown in FIG. 10C, the starter assembly 260 includes a rotor 262 mounted on a high pressure shaft 232. The starter assembly 260 also may be mounted on the drive shaft 230 and 330. The rotor 262 has a plurality of permanent magnets disposed circumferentially around the rotor 262. An electromagnetic stator is positioned radially outward from and around the rotor 262. The stator is configured as an electrical armature or field winding. In one embodiment, the stator is mounted in a pivotal compressor vane or high pressure nozzle 222 (not shown). The stator is in electrical communication with a power supply (e.g., a battery that provides electrical current to the windings of the stator to cause the rotor to rotate) via a suitable conductor. The starter assembly 260 is configured to start the turbine engine 210 by rotating the high pressure shaft 232 and the core 240 to provide compressed gas to the mechanical output assembly 250. The starter assembly 260 is configured to start the gas turbine unassisted by a gear starter system.

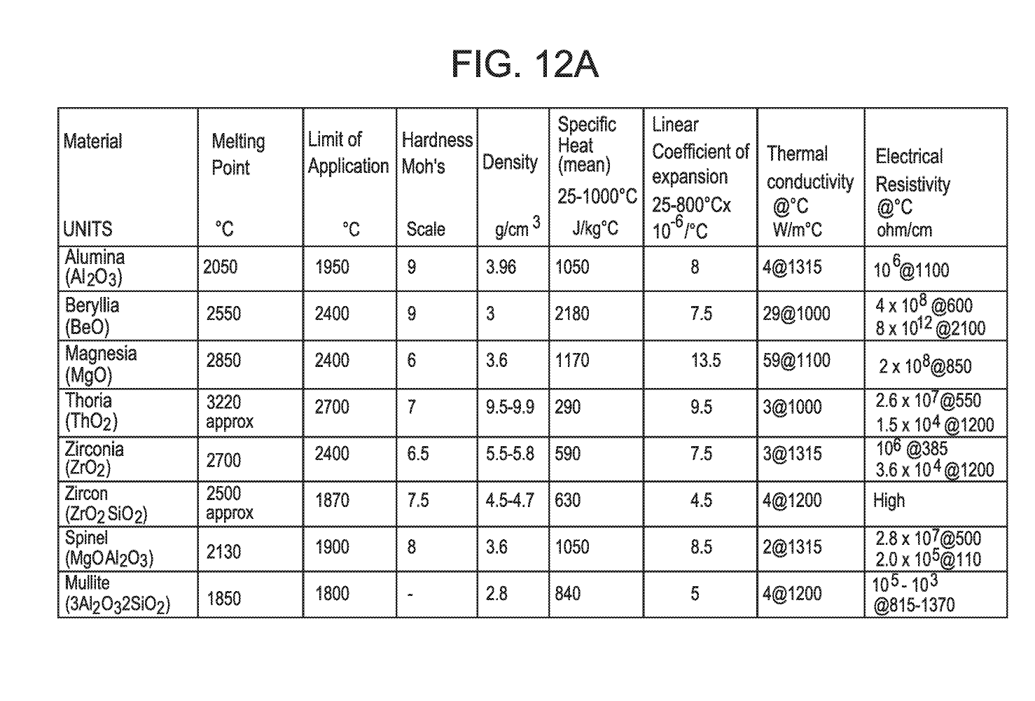

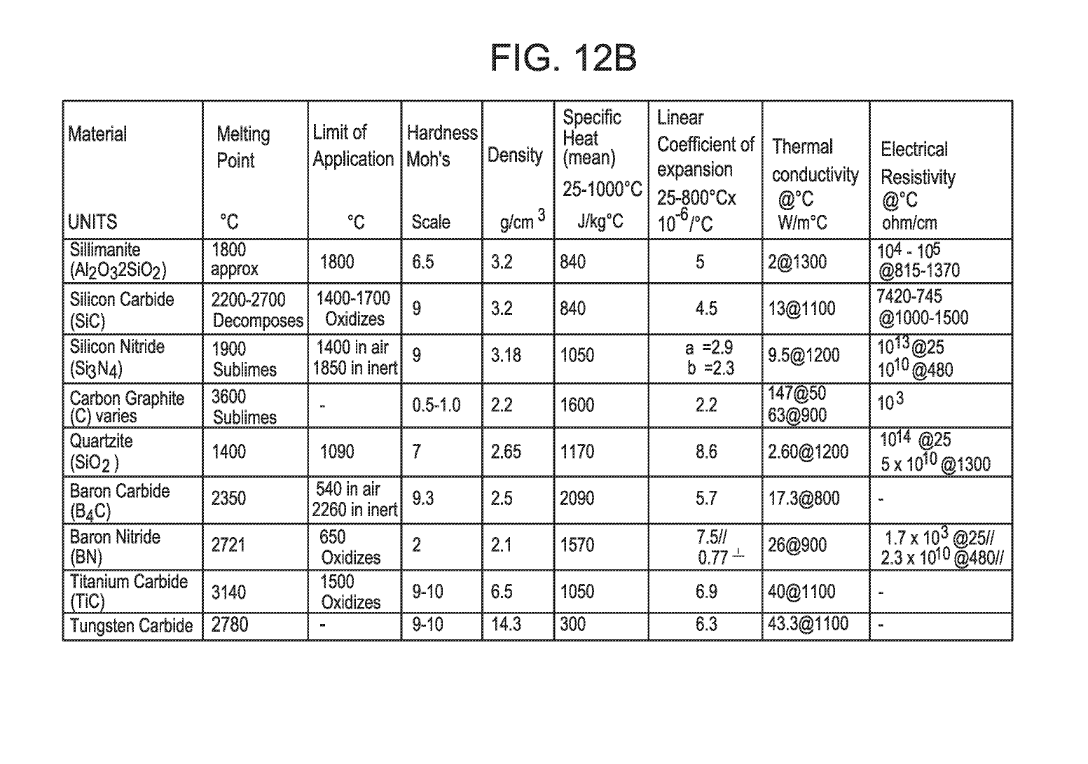

In one embodiment, one or both of the core 240 and the mechanical output assembly 250 of the gas turbine engine 210 is fabricated as a one-piece unit. In one embodiment, the high pressure rotor assembly 220 is fabricated as a one-piece unit. In one embodiment, the low pressure rotor assembly 228 is fabricated as a one-piece unit. In one embodiment, the high pressure vane assembly 222 is fabricated as a one-piece unit. In one embodiment, the low pressure vane assembly 226 is fabricated as a one-piece unit. Any of the aforementioned one-piece units may be fabricated from a refractory ceramic particularly selected for use in a high temperature application in the range of about 1600° F. to about 2400° F. Examples of such refractory ceramics of provided in FIG. 12 and are available from Convectronics, Inc. of Massachusetts. Any of the aforementioned one-piece units may be fabricated from a refractory metal such as for example tungsten, molybdenum, and tantalum.

In one embodiment, the combustor and diffuser assembly 224 is includes a fiber-reinforced plastic (“FRP”) (also known as a fiber-reinforced polymer) matrix core embedded within the refractory ceramic. In one embodiment, the combustor and diffuser assembly 224 includes a fibrous organic elastomeric matrix (“FOEM”) core embedded within the refractory ceramic. In one embodiment, the combustor and diffuser assembly 224 includes a thermoplastic fiber matrix core embedded within the refractory ceramic. In each embodiment, the matrix core provides additional structural integrity to the combustor and diffuser assembly 224 while dampening the vibration and sound emitted therefrom. In one embodiment, the combustor and diffuser assembly 224 includes a liner installed therein fabricated from a synthetic porous ultralight material derived from a gel in which the liquid component of the gel is replaced with a gas. Such a material is commonly referred to as an aerogel and provides a solid with extremely low density and low thermal conductivity.

All external components required for operation of the modular unit 10 are mounted on the internal walls 102, 106, 108, 110 and 112 of the housing 100 thereby eliminating the complexity of mounting such hardware to the turbine engine 200. Such a configuration thereby substantially reduces the parasitic drag of the modular unit 10 thereby substantially increasing the thermal efficiency of the modular unit 10. Such a configuration also substantially reduces the maintenance and wear issues encountered with the high temperature and harmonics associated with the operation of the turbine engine 200. Such external components that can be mounted on the internal walls 102, 106, 108, 110 and 112 of the housing 100 for operation of the turbine engine 200 include, but is not limited to: a fuel control system, fuel pump and fuel tank; an oil control system, lube and scavenge pumps and an oil tank; a hydraulic pump and fluid reservoir; an accessory drive gear; a plurality of sensors for controlling and monitoring the operation of the turbine engine; other piping and instrumentation; and a fire suppression system. Moreover, all of the external components required for operation of the modular turbine engine can be powered with twelve or twenty-four voltage power supplied by a rechargeable electrical power supply 50 as shown in FIG. 11C such as for example an accessory electric motor or one or more batteries or a battery pack or solar power. Thus, the load on the core 240 of the turbine engine 200, 210 is correspondingly reduced thereby increasing the efficiency of the turbine engine 200, 210.

As disclosed herein above, the maximum thermal efficiency at which a typical turbine engine operates is in the range of about 45% to about 55%. In contrast, the thermal efficiency of the turbine engine 200, 210 of the self-contained modular turbine engine unit of the present invention is in the range of about 75% to about 85%. Such an increase in the thermal efficiency of the turbine engine 200, 210 represents over a 50% increase over the thermal efficiency of turbine engines known in the art at the time of the present invention. Thus, the self-contained modular turbine engine power generator of the present invention is an all-inclusive, turnkey power plant having the turbine engine 200, all external components required for operation of the turbine engine 200, and a means for starting the engine such as a 12V/24V rechargeable power supply and an electromechanical starter, all enclosed within an easily transportable and deployable container or housing 100.

Although the invention has been described with reference to particular embodiments thereof, it will be understood by one of ordinary skill in the art, upon a reading and understanding of the foregoing disclosure that numerous variations and alterations to the disclosed embodiments will fall within the scope of this invention and of the appended claims.

What is claimed is:

1. A high efficiency self-contained modular turbine engine unit for generating power, the modular turbine engine unit comprising:
a housing having a housing frame, a top panel, a bottom panel, a first side panel, a second side panel, a third side panel and a fourth side panel, each of the panels being removeably secured to the housing frame;
an air intake defined in the housing; and
an exhaust port defined in the housing;
a turbine engine positioned and operable within the housing, the turbine engine comprising,
a drive shaft defining a drive shaft centerline,
at least one compressor rotor assembly mounted on the drive shaft,
at least one compressor vane assembly mounted on the drive shaft proximate to and downstream from the at least one compressor rotor assembly,
a combustor and diffuser assembly mounted on the drive shaft proximate to and downstream from the at least one compressor vane assembly, the combustor and diffuser assembly comprising a one-piece unit defining a shroud extending forwardly therefrom to define a flowpath for compressed air exiting the at least one compressor vane assembly, and a plurality of combustion flow channels extending rearwardly and radially inwardly thereby forming a flowpath angle in the range from about 15° to about 35° with the drive shaft centerline,
an igniter positioned on a forward end of each flow channel configured to ignite a fuel/oxygen mixture introduced into the at least one compressor rotor assembly,
at least one turbine vane assembly mounted on the drive shaft proximate to and downstream from the combustor and diffuser assembly, and
at least one turbine rotor assembly mounted on a drive shaft proximate to and downstream from the at least one turbine vane assembly; and
a forward engine mount and a rear engine mount configured for positioning and securing the turbine engine within the housing;
wherein external components required for operation of the turbine engine are mounted within the housing on at least one of the top panel, first side panel, second side panel, third side panel and fourth side panel.

2. The high efficiency self-contained modular turbine engine unit for generating power of claim 1, further comprising:
a mechanical-to-electrical power conversion device configured to receive and convert mechanical power generated by the turbine engine.

3. The high efficiency self-contained modular turbine engine unit for generating power of claim 1, wherein at least one of the high pressure rotor assembly, the low pressure rotor assembly, the high pressure vane assembly and low pressure vane assembly is fabricated as a one-piece unit.

4. The high efficiency self-contained modular turbine engine unit for generating power of claim 3, wherein at least one of the combustor and diffuser assembly, high pressure rotor assembly, the low pressure rotor assembly, the high pressure vane assembly and low pressure vane assembly is fabricated from a refractory ceramic.

5. The high efficiency self-contained modular turbine engine unit for generating power of claim 4, wherein the refractory ceramic includes a fiber-reinforced plastic matrix core embedded within the refractory ceramic.

6. The high efficiency self-contained modular turbine engine unit for generating power of claim 1, the air intake further comprising a mixer positioned therein and configured for mixing air or oxygen with fuel to provide a fuel/air admixture to the turbine engine.

7. The high efficiency self-contained modular turbine engine unit for generating power of claim 1, the turbine engine further comprising:
a plurality of high pressure rotor assemblies fabricated as a one-piece unit.

8. The high efficiency self-contained modular turbine engine unit for generating power of claim 7, wherein the one-piece plurality of high pressure rotor assemblies is fabricated from a refractory ceramic.

9. The high efficiency self-contained modular turbine engine unit for generating power of claim 1, the turbine engine further comprising:
a plurality of low pressure rotor assemblies fabricated as a one-piece unit.

10. The high efficiency self-contained modular turbine engine unit for generating power of claim 9, wherein the one-piece plurality of low pressure rotor assemblies is fabricated from a refractory ceramic.

11. The high efficiency self-contained modular turbine engine unit for generating power of claim 1, the turbine engine further comprising:
a plurality of high pressure vane assemblies fabricated as a one-piece unit.

12. The high efficiency self-contained modular turbine engine unit for generating power of claim 11, wherein the one-piece plurality of high pressure vane assemblies is fabricated from a refractory ceramic.

13. The high efficiency self-contained modular turbine engine unit for generating power of claim 1, the turbine engine further comprising:
a plurality of low pressure assemblies fabricated as a one-piece unit.

14. The high efficiency self-contained modular turbine engine unit for generating power of claim 13, wherein the one-piece plurality of low pressure vane assemblies is fabricated from a refractory ceramic.

15. The high efficiency self-contained modular turbine engine unit for generating power of claim 1, further comprising:
a forward magnetic bearing and a rearward magnetic bearing configured to support the turbine engine.
